(19) United States
(12) Patent Application Publication
(10) Pub. No.: US 2026/0057648 A1
(43) Pub. Date: Feb. 26, 2026

(54) INFORMATION PROCESSING APPARATUS, INFORMATION PROCESSING METHOD, AND COMPUTER-READABLE NON-TRANSITORY STORAGE MEDIUM

(71) Applicant: SONY GROUP CORPORATION, Tokyo (JP)

(72) Inventors: Yoshiyuki AKIYAMA, Tokyo (JP); Takuro KAWAI, Tokyo (JP)

(21) Appl. No.: 19/104,699

(22) PCT Filed: Jul. 26, 2023
(86) PCT No.: PCT/JP2023/027316

§ 371 Date: Feb. 18, 2025

(30) Foreign Application Priority Data
Aug. 26, 2022 (JP) 2022-135246

(51) Int. Cl. G06V 10/774; G06T 3/4053; G06V 10/74; G06V 30/18; G06V 40/16; G10L 25/57

(52) U.S. Cl. CPC G06V 10/774; G06T 3/4053; G06V 10/761; G06V 30/18; G06V 40/168; G10L 25/57

(57) ABSTRACT

An information processing apparatus of the present disclosure includes a control unit. The control unit acquires unique feature information unique to a face of a target person from a low-quality captured face image including the face of the target person. The control unit extracts a plurality of third person images different from the target person having a feature corresponding to a feature of the face of the target person from a learning database based on the unique feature information.

The control unit outputs a learning data set for quality enhancement processing of improving quality of the low-quality captured face image based on the plurality of third person images.

### FIELD

The present disclosure relates to an information processing apparatus, an information processing method, and a computer-readable non-transitory storage medium.

### BACKGROUND

A super-resolution technique for outputting an input image with high resolution is known. In the super-resolution technique, for example, a plurality of pieces of high-resolution image data stored in a database is used to enhance quality of an input image.

A technique for protecting personal information by generating composite data from high-resolution image data in a case where the high-resolution image data includes personal information such as a face image is known.

In addition, a technique for determining representative data from a data set including a plurality of data is known.

### CITATION LIST

### Patent Literature

Patent Literature 1: WO 2018/131105 A

Patent Literature 2: JP 2013-149186 A

### SUMMARY

### Technical Problem

In order to increase the resolution (high quality) of an image (hereinafter, also referred to as a face image) including the face of a specific person, learning data sufficiently including a high-quality face image (hereinafter, it is also referred to as a high-quality face image) of the person himself/herself is required. However, in order to collect a large amount of high-quality face images of a specific person, time-consuming and costly photographing is required. In addition, there is a case where it is difficult to collect a high-quality face image in the first place, such as a case where a specific person is not alive.

As described above, in a case where a high-quality face image of a specific person cannot be collected, it is generally conceivable to enhance the quality of the face image using a high-quality face image of a third person different from the specific person.

However, when the quality is enhanced using the high-quality face image of a third person, the feature of a third person different from the feature of the principal may be reflected in the face image with the enhanced quality. As described above, a high-quality face image that give the impression of a person different from a specific person may be generated.

Therefore, the present disclosure provides a mechanism capable of collecting learning data for achieving high quality reflecting features of a specific person.

Note that the above problem or object is merely one of a plurality of problems or objects that can be solved or achieved by the plurality of embodiments disclosed in the present specification.

### Solution to Problem

An information processing apparatus of the present disclosure includes a control unit. The control unit acquires unique feature information unique to a face of a target person from a low-quality captured face image including the face of the target person. The control unit extracts a plurality of third person images different from the target person having a feature corresponding to a feature of the face of the target person from a learning database based on the unique feature information. The control unit outputs a learning data set for quality enhancement processing of improving quality of the low-quality captured face image based on the plurality of third person images.

### BRIEF DESCRIPTION OF DRAWINGS

FIG. 1 is a diagram illustrating an outline of image processing according to a proposed technique of the present disclosure.

FIG. 2 is a block diagram illustrating a configuration example of an information processing apparatus according to an embodiment of the present disclosure.

FIG. 3 is a diagram illustrating an example of a learning image stored in a learning DB according to an embodiment of the present disclosure.

FIG. 4 is a diagram illustrating an example of a control unit according to an embodiment of the present disclosure.

FIG. 5 is a block diagram illustrating a configuration example of a data set construction unit according to an embodiment of the present disclosure.

FIG. 6 is a diagram illustrating an example of image acquisition processing by an image acquisition unit according to an embodiment of the present disclosure.

FIG. 7 is a flowchart illustrating an example of a flow of image processing according to an embodiment of the present disclosure.

FIG. 8 is a flowchart illustrating an example of a flow of data set generation processing according to an embodiment of the present disclosure.

FIG. 9 is a diagram illustrating a hardware configuration example of the information processing apparatus.

### DESCRIPTION OF EMBODIMENTS

Hereinafter, embodiments of the present disclosure will be described in detail with reference to the accompanying drawings. Note that, in the present specification and the drawings, components having substantially the same functional configuration are denoted by the same reference numerals, and redundant description is omitted.

One or more embodiments (including examples and modifications) described below can each be implemented independently. On the other hand, at least a part of the plurality of embodiments described below may be appropriately combined with at least some of other embodiments. The plurality of embodiments may include novel features different from each other. Therefore, the plurality of embodiments can contribute to solving different objects or problems, and can exhibit different effects.

### 1. Introduction

### 1.1. Background

There is a great demand for enhancing the quality of low quality images and videos (moving images). In particular, high quality of a face image including a face of a specific individual is required in various scenes.

For example, in online video exchange such as video conference and video telephone, high compressed and low quality online video may be transmitted. It is desirable to restore such a low-quality online video to a high-quality video. Alternatively, there is a demand for, for example, revitalizing old video (for example, a movie and the like).

An old video such as an online video or a movie includes a face image of a specific individual. Therefore, high quality is required for a low quality face image (hereinafter, also referred to as a deteriorated face image) including a specific individual's face.

Here, in order to enhance the quality of a deteriorated face image of an individual, that is, to enhance the image quality, learning data using a sufficient amount of high-quality face images of the person in question is required.

However, in order to collect a large amount of high-quality face images including an individual's face, time-consuming and costly photographing is required. In addition, for example, in the case of an old video, an individual included in the video is not already alive, and it may be difficult to collect a high-quality face image of the individual.

As described above, in a case where it is difficult to collect a high-quality face image of an individual, a method of using a face image of another person (third person) is generally considered.

However, when a high-quality face image of a third person is used to enhance the quality of a deteriorated face image of an individual, a high-quality face image reflecting the features of the third person is generated, and there is a risk that an image that gives the impression of a person different from an individual (hereinafter, also referred to as a target person) to be enhanced in quality is generated.

For example, when the quality of the target person is enhanced using a high-quality face image of a third person who is a different race from the target person, there is a risk that a high-quality face image in which the feature of the target person is not reflected, such as a change in the color of the pupil of the target person, is generated.

In addition, in order to express various faces such as facial expressions in an enhanced image, it is desirable to collect high-quality face images having variations of facial expressions. For example, when learning for high quality is performed using a high-quality face image of expressionlessness with poor expression, the face included in the image generated based on the learning tends to be expressionless. As described above, in order to reproduce a face with an expression by enhancing the quality, it is desirable to collect a high-quality face image with a wide variation of facial expressions.

In this manner, it is desirable to collect the learning data for performing the quality enhancement reflecting the feature of the target person and perform the learning, thereby performing the quality enhancement reflecting the feature of the target person.

### 1.2. Outline of Proposed Technique

Therefore, the present disclosure proposes a new technique for solving the above-described problem.

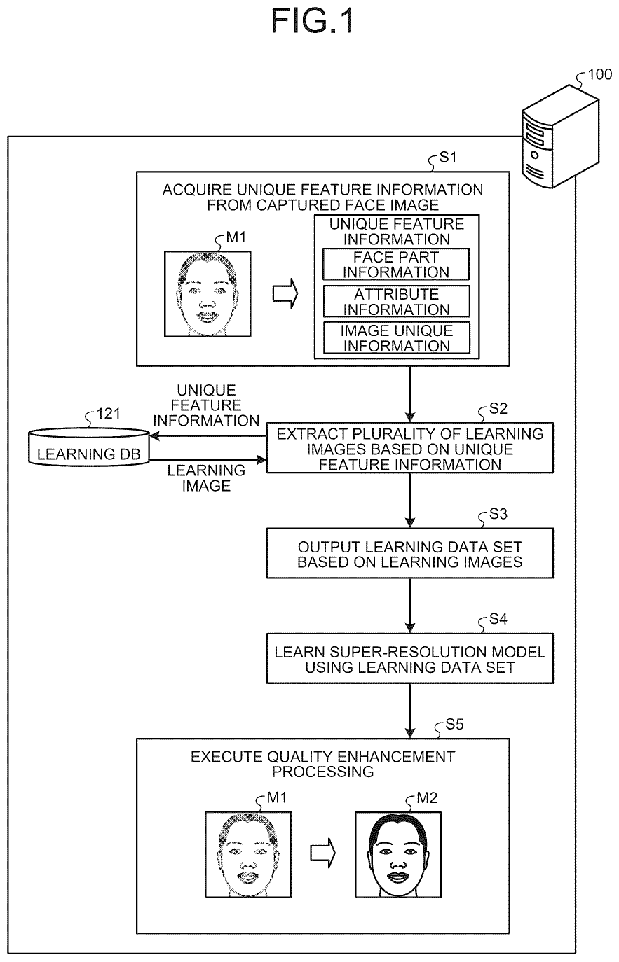

FIG. 1 is a diagram illustrating an outline of image processing according to a proposed technique of the present disclosure. The image processing illustrated in FIG. 1 is executed by an information processing apparatus 100, for example.

First, the information processing apparatus 100 acquires unique feature information unique to the face of the target person from a photographed face image M1 (step S1). The photographed face image M1 is, for example, a low-quality image including the face of the target person. The photographed face image M1 may be, for example, a frame image obtained by extracting one frame of image from the moving image. In addition, the photographed face image M1 may be a region image obtained by cutting out a face region of the image.

Here, the unique feature information unique to the face of the target person is, for example, information including a feature that specifies an individual of the target person. The unique feature information is, for example, information including a feature of a face unique to the target person.

The unique feature information includes, for example, at least one of face part information, attribute information, and image unique information. The face part information includes, for example, at least one piece of information regarding the shape, position, color, and the like of the face part included in the photographed face image M1. The attribute information includes, for example, at least one piece of information regarding gender, age, race, language, and the like of the target person. The image unique information includes, for example, information unique to the face of the target person in the photographed face image M1. The image unique information includes, for example, at least one piece of information regarding an emotion, an utterance, and a tone of a voice of the target person in the photographed face image M1.

As described above, the information processing apparatus 100 acquires, for example, information characterized as the face of the target person as the unique feature information.

Next, the information processing apparatus 100 extracts a plurality of learning images (an example of a third person image) having a feature corresponding to the feature of the face of the target person based on the unique feature information (step S2). The learning image is, for example, an image including a face of a third person different from the target person. The learning image is an image of higher quality than the photographed face image M1. The learning image is stored in, for example, a learning database (DB) 121 in association with unique feature information unique to a face of a third person. For example, the information processing apparatus 100 searches the learning DB 121 using the unique feature information of the target person, and acquires a learning image similar to the feature unique to the face of the target person.

The information processing apparatus 100 outputs the learning data set based on the plurality of learning images (step S3). This learning data set is used, for example, for learning for performing quality enhancement processing for enhancing the quality of a low-quality captured face image.

As described above, the information processing apparatus 100 extracts the learning image based on the unique feature information unique to the face of the target person, so that it is possible to extract more learning images of a third person including features similar to the features of the face of the target person. The information processing apparatus 100 can construct a learning data set useful for learning by extracting a learning image using features (face part information, attribute information, image unique information, and the like) useful for face expression in a complex manner.

As a result, even in a case where a large amount of high-quality face images of the target person cannot be collected, the information processing apparatus 100 can construct a substitute image data set that can be used for learning in order to enhance the quality of the captured face image of the target person.

Subsequently, the information processing apparatus 100 learns the super-resolution model using the learning data set (step S4). The information processing apparatus 100 executes the quality enhancement processing using the learned super-resolution model (step S5).

As described above, the information processing apparatus 100 learns the super-resolution model used in the quality enhancement processing using the learning data set including the learning image having the feature corresponding to the feature of the face of the target person. The information processing apparatus 100 executes the quality enhancement processing using the learned super-resolution model.

As a result, even in a case where a large amount of high-quality face images of the target person cannot be collected, the information processing apparatus 100 can generate a high-quality image in which the features of the face of the target person are more reflected from the captured face image.

Hereinafter, the information processing apparatus 100 will be described in detail.

### 2. Configuration Example of Information Processing Apparatus

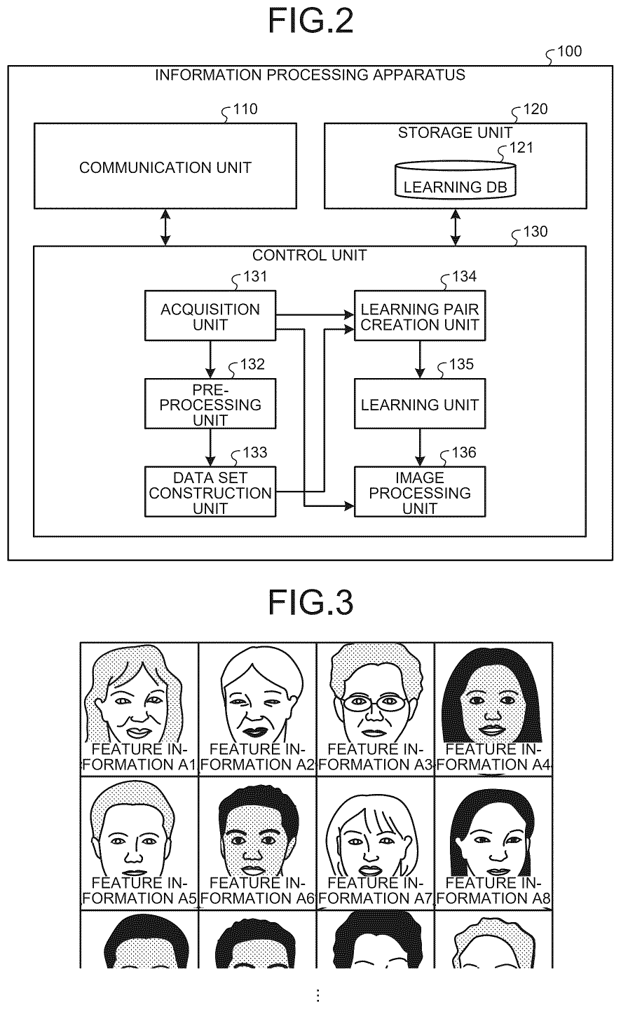

FIG. 2 is a block diagram illustrating a configuration example of the information processing apparatus 100 according to an embodiment of the present disclosure. The information processing apparatus 100 illustrated in FIG. 2 includes a communication unit 110, a storage unit 120, and a control unit 130.

### Communication Unit 110

The communication unit 110 is a communication interface for communicating with other devices. The communication unit 110 may be a network interface or a device connection interface. For example, the communication unit 110 may be a local area network (LAN) interface such as a network interface card (NIC), or may be a USB interface including a universal serial bus (USB) host controller, a USB port, and the like. In addition, the communication unit 110 may be a wired interface or a wireless interface.

The communication unit 110 communicates with another information processing apparatus 100, a camera, and the like under the control of the control unit 130 to acquire an input moving image.

### Storage Unit 120

The storage unit 120 is a data readable/writable storage device such as a dynamic random access memory (DRAM), a static random access memory (SRAM), a flash memory, or a hard disk. The storage unit 120 includes the learning DB 121. As described above, the learning DB 121 stores a learning image.

FIG. 3 is a diagram illustrating an example of a learning image stored in the learning DB 121 according to an embodiment of the present disclosure.

As illustrated in FIG. 3, the learning DB 121 stores a plurality of learning images. The learning image is, for example, an image including a face of a person. This person may be the same person as the target person, or may be a third person different from the target person.

The learning image is used as a teacher image of the super-resolution model in a learning unit 135. The learning image has an image quality higher than the image quality of the image (captured face image) before the quality enhancement processing. For example, the learning image has high image quality required as image quality of a high-quality image generated by the quality enhancement processing.

The learning DB 121 stores the learning image and the unique feature information unique to the face of the person included in the learning image in association with each other. The unique feature information unique to the face of the person included in the learning image can include information of the same type as the unique feature information of the target person extracted by the information processing apparatus 100, for example, face part information and attribute information to be described later. Alternatively, at least a part of the unique feature information of the learning image may be information of the same type as at least a part of the unique feature information of the target person (for example, only face part information).

Note that, in a case of distinguishing between the unique feature information of the target person extracted by the information processing apparatus 100 and the unique feature information of the person included in the learning image, the unique feature information of the person included in the learning image may be described as the feature information.

### Control Unit 130

Returning to FIG. 2, the control unit 130 is a controller that controls each unit of the information processing apparatus 100. The control unit 130 is realized by, for example, a processor such as a central processing unit (CPU) or a micro processing unit (MPU). For example, the control unit 130 is implemented by a processor executing various programs stored in a storage device inside the information processing apparatus 100 using a random access memory (RAM) and the like as a work area. Note that the control unit 130 may be realized by an integrated circuit such as an application specific integrated circuit (ASIC) or a field programmable gate array (FPGA). Any of the CPU, the MPU, the ASIC, and the FPGA can be regarded as a controller.

The control unit 130 includes an acquisition unit 131, a preprocessing unit 132, a data set construction unit 133, a learning pair creation unit 134, the learning unit 135, and an image processing unit 136. Each block (acquisition unit 131 to image processing unit 136) constituting the control unit 130 is a functional block indicating a function of the control unit 130. These functional blocks may be software blocks or hardware blocks. For example, each functional block described above may be one software module realized by software (microprograms) or one circuit block on a semiconductor chip (die). Of course, each functional block may be one processor or one integrated circuit. A configuration method of each functional block is arbitrary. Note that the control unit 130 may include a functional unit different from the functional blocks described above.

### Acquisition Unit 131

The acquisition unit 131 acquires the input moving image via the communication unit 110, for example. The input moving image is an image to be subjected to the quality enhancement processing by the information processing apparatus 100. Note that, here, a case where the target of the quality enhancement processing is a moving image will be described, but the target of the quality enhancement processing may be a still image. That is, the acquisition unit 131 may acquire the input still image.

In addition, the acquisition unit 131 may acquire, for example, sound data or text data. The sound data can be acquired in association with the moving image using, for example, a microphone (not illustrated) or a microphone of a camera (not illustrated) included in the information processing apparatus 100. Alternatively, the sound data may be data corresponding to a video. The sound data can include natural sounds such as music, wave sounds, rain sounds, and murmuring sounds, machine sounds, and the like, in addition to the voice of a person (for example, a target person).

The text data is, for example, data input by a user using the information processing apparatus 100 via an input device (not illustrated) such as a keyboard.

The acquisition unit 131 outputs the acquired input moving image to the preprocessing unit 132, the learning pair creation unit 134, and the image processing unit 136. The acquisition unit 131 outputs the acquired sound data and text data to the preprocessing unit 132.

Note that the information acquired by the acquisition unit 131 is not limited to the input moving image, the sound data, and the text data. The acquisition unit 131 may acquire at least one of the input moving image, the sound data, and the text data. Alternatively, the acquisition unit 131 may acquire information other than the input moving image, the sound data, and the text data described above. For example, the acquisition unit 131 may acquire biological data detected by a vital sensor such as a heart rate.

### Preprocessing Unit 132

The preprocessing unit 132 performs preprocessing on the input data (for example, an input moving image, sound data, text data, and the like) acquired by the acquisition unit 131, and generates input information to be used for processing in the data set construction unit 133 in the subsequent stage. The preprocessing unit 132 generates a captured face image from the input moving image. The preprocessing unit 132 generates voice information from the sound data. The preprocessing unit 132 generates text information from the text data.

The preprocessing unit 132 outputs the generated input information to the data set construction unit 133.

### Data Set Construction Unit 133

The data set construction unit 133 constructs a learning data set based on the input information. For example, the data set construction unit 133 extracts unique feature information unique to the face of the target person based on the input information. The data set construction unit 133 constructs a learning data set based on the unique feature information.

The data set construction unit 133 outputs the constructed learning data set to the learning pair creation unit 134.

### Learning Pair Creation Unit 134

The learning pair creation unit 134 generates learning pair data including a teacher image and a student image based on the learning data set and the input moving image. This learning pair data is used for learning in the learning unit 135 in the subsequent stage.

The learning pair creation unit 134 outputs the learning pair data to the learning unit 135.

### Learning Unit 135

The learning unit 135 performs machine learning using learning pair data to generate a super-resolution model. More specifically, the learning unit 135 performs machine learning using the learning pair data and calculates the coefficient of the super-resolution model. The super-resolution model is used for quality enhancement processing by the image processing unit 136 in the subsequent stage.

The learning unit 135 outputs coefficient data related to the coefficients of the super-resolution model to the image processing unit 136.

### Image Processing Unit 136

The image processing unit 136 executes the quality enhancement processing on the input moving image including the captured face image using the super-resolution model corresponding to the coefficient data, and generates the output moving image.

The image processing unit 136 presents the output moving image to the user using the information processing apparatus 100, for example, by outputting the output moving image to a display device (not illustrated). Alternatively, the image processing unit 136 may store the generated output moving image in the storage unit 120.

### 2.1. Details of Control Unit

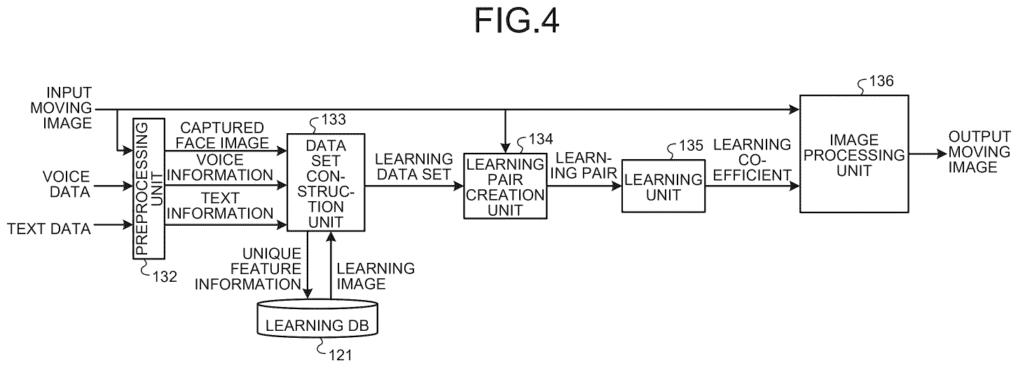

FIG. 4 is a diagram illustrating an example of the control unit 130 according to an embodiment of the present disclosure. In FIG. 4, the acquisition unit 131 is not illustrated.

### Preprocessing Unit 132

The input moving image, the sound data, and the text data acquired by the acquisition unit 131 are input to the preprocessing unit 132. The preprocessing unit 132 performs preprocessing on the input moving image, the sound data, and the text data to generate a captured face image, voice information, and text information.

For example, the preprocessing unit 132 cuts out a frame from the input moving image to generate a frame image (input still image). The preprocessing unit 132 may generate an input still image for each frame, or may generate an input still image for each certain cycle such as several frames.

In a case where the input still image includes the face of the target person, the preprocessing unit 132 sets the input still image as the captured face image. Alternatively, the preprocessing unit 132 may cut out the face region of the target person included in the input still image to obtain the captured face image.

In addition, the preprocessing unit 132 acquires, for example, text information included in an input still image (an example of a captured image including a target person). The preprocessing unit 132 sets the acquired text information as text information corresponding to the input still image.

The preprocessing unit 132 generates voice information from sound data corresponding to the input moving image. The sound data is, for example, data including a voice uttered by the target person corresponding to the input moving image.

For example, the preprocessing unit 132 cuts out sound data of a predetermined period including the time when the input still image is captured from the sound data as voice information, and associates the sound information with the input still image. Alternatively, the preprocessing unit 132 may cut out, from the sound data, each word or phoneme uttered at the time when the input still image was captured as sound information, and associate the voice information with the input still image.

Note that the preprocessing unit 132 may generate voice information from which the unique feature information can be extracted by the data set construction unit 133 in the subsequent stage, for example. The length and the like (for example, for a certain period of time, word units or phoneme units) of the voice information generated by the preprocessing unit 132 is not limited.

In addition, for example, in a case where sound other than voice, such as music or natural sound, is included in the sound data, the preprocessing unit 132 extracts the voice uttered by the target person from the sound data and generates the voice information.

In addition, for example, the preprocessing unit 132 may convert the voice of the target person from the sound data into a text (utterance contents) to generate text information. The preprocessing unit 132 sets the contents (text) of the utterance corresponding to the time when the input still image was captured as text information corresponding to the input still image.

In addition, the preprocessing unit 132 generates text information from the text data. The text data includes, for example, data acquired from other than the input moving image and the sound data, such as personal data of the target person. As described above, the text data includes data input by the user arbitrarily via an input device (not illustrated) for example.

The preprocessing unit 132 generates text information from at least one of the input moving image, the sound data, and the text data.

The preprocessing unit 132 outputs at least one of the captured face image, the voice information, and the text information corresponding to the input moving image to the data set construction unit 133.

Note that in a case where the input moving image, the sound data, and the text data are information that can be processed by the data set construction unit 133, in other words, in a case where the acquisition unit 131 acquires the captured face image, the voice information, and the text information, the processing in the preprocessing unit 132 may be omitted.

In addition, the data processed by the preprocessing unit 132 is not limited to the input moving image, the sound data, and the text data. The preprocessing unit 132 generates at least one of the captured face image, the voice information, and the text information from at least one of the input moving image, the sound data, and the text data, and outputs the generated at least one of the captured face image, the voice information, and the text information to the data set construction unit 133 in the subsequent stage.

In addition, for example, in a case where the acquisition unit 131 acquires biological data, the preprocessing unit 132 may generate biological information from which the unique feature information can be extracted by the data set construction unit 133 in the subsequent stage from the biological data.

### Data Set Construction Unit 133

The data set construction unit 133 extracts unique feature information unique to the face of the target person from the captured face image, the voice information, and the text information. The data set construction unit 133 searches the learning DB 121 using the unique feature information, and acquires a plurality of learning images including a person having feature information close to the unique feature information of the target person.

The data set construction unit 133 outputs the learning data set including the learning image to the learning pair creation unit 134.

### Learning Pair Creation Unit 134

The learning image included in the learning data set is a high-quality face image including a face of a person. More specifically, the learning image is an image having higher quality (higher resolution) than the captured face image. This learning image is used as a teacher image in machine learning by the learning unit 135 in the subsequent stage.

The learning pair creation unit 134 generates a student image corresponding to the teacher image from the learning image. The learning pair creation unit 134 acquires the input moving image from the acquisition unit 131. The learning pair creation unit 134 estimates the deterioration contents (for example, noise, resolution, and the like) of the input moving image based on the input moving image. The learning pair creation unit 134 generates a student image from the learning image using the estimated deterioration contents. The learning pair creation unit 134 sets the learning image and the student image as a learning pair.

The learning pair creation unit 134 generates a student image from at least some learning images included in the learning data set and creates a learning pair. The learning pair creation unit 134 outputs the learning pair to the learning unit 135.

### Learning Unit 135

The learning unit 135 uses a learning pair to learn a super-resolution model to be used for quality enhancement processing of converting a low-quality (low-resolution) captured face image into a high-quality (high-resolution) face image. The learning unit 135 learns a super-resolution model using, for example, a super-resolution technique.

Alternatively, the learning unit 135 may relearn an already learned super-resolution model by using a learning pair. For example, the learning unit 135 calculates a super-resolution model specialized for the target person by relearning the super-resolution model for enhancing the quality (increasing the resolution) of the deteriorated face image of a general person using the learning pair.

The learning unit 135 outputs the calculated learning coefficient of the super-resolution model to the image processing unit 136.

### Image Processing Unit 136

The image processing unit 136 performs the quality enhancement processing on the input moving image according to the learning coefficient to generate the output moving image. For example, the image processing unit 136 inputs the input moving image to the super-resolution model having the learning coefficient calculated by the learning unit 135. The image processing unit 136 sets the output of the super-resolution model as the output moving image.

The image processing unit 136 presents the generated output moving image to the user by fishing on a display device (not illustrated). Alternatively, the image processing unit 136 stores the generated output moving image in the storage unit 120.

### Detailed Example of Data Set Construction Unit 133

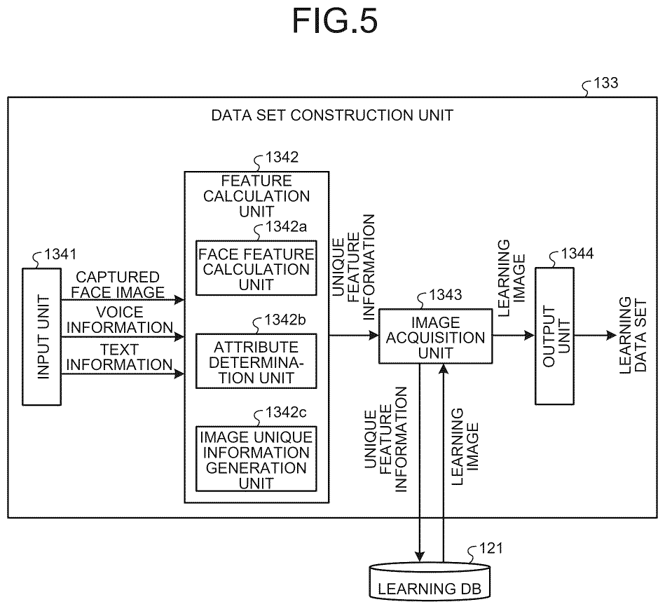

Next, details of the data set construction unit 133 will be described with reference to FIG. 5. FIG. 5 is a block diagram illustrating a configuration example of the data set construction unit 133 according to an embodiment of the present disclosure.

The data set construction unit 133 illustrated in FIG. 5 includes an input unit 1341, a feature calculation unit 1342, an image acquisition unit 1343, and an output unit 1344.

### Input Unit 1341

The input unit 1341 receives an input of information on the target person. The input unit 1341 acquires at least one of the captured face image, the voice information, and the text information from the preprocessing unit 132. The input unit 1341 outputs at least one of the captured face image, the voice information, and the text information to the feature calculation unit 1342.

### Feature Calculation Unit 1342

The feature calculation unit 1342 calculates and determines the feature of the target person using various input information acquired by the input unit 1341.

The feature calculation unit 1342 extracts unique feature information unique to the face of the target person using the captured face image, the voice information, and the text information input as the information of the target person.

The unique feature information of the target person includes, for example, information regarding a human phase of the target person. The human phase here means a face (facial feature or expression) unique to the target person. The information regarding the human phase includes, for example, information regarding the position of face parts such as eyes, nose, and mouth, shape, color, texture of the skin, and the like.

As described above, the unique feature information includes information for specifying the feature unique to the target person. That is, the unique feature information includes information (determination information for determining that another person is the target person) regarding a feature of a face that serves as a reference for determining that another person is the person in question.

The unique feature information of the present embodiment indicates a high-dimensional feature amount including an image feature amount such as a face feature and a text feature amount such as an attribute/emotion.

The feature calculation unit 1342 calculates or determines, for example, at least one of face part information, attribute information, and image unique information as the unique feature information.

The face part information includes information regarding a face feature of the target person, such as a face part position, a part shape, and a part color of the target person. The feature calculation unit 1342 calculates face part information mainly based on the captured face image.

The attribute information includes information regarding attributes of the target person, such as gender, age, race, and language of the target person. The feature calculation unit 1342 determines the attribute of the target person based on at least one of the captured face image, the voice information, and the text information, and generates the attribute information.

The image unique information is information unique to the captured face image of the target person. The image unique information includes, for example, feeling information regarding emotions such as facial expressions, utterance contents (words), and voice tones of the target person. The feature calculation unit 1342 determines emotion of the target person based on at least one of the captured face image, the voice information, and the text information, and generates image unique information.

In this manner, the feature calculation unit 1342 can extract the unique feature information using information (voice information or text information) other than the captured face image. Generally, the facial feature of the target person is acquired from the image. However, depending on deterioration of the image, a direction of the face, and illuminance, there may be a case where the feature of the face cannot be sufficiently calculated from the image.

On the other hand, the feature calculation unit 1342 according to the present exemplary embodiment extracts unique feature information by using voice information and text information in addition to the captured face image. As a result, the feature calculation unit 1342 can capture the features of the individual target person complementarily or multidimensionally. The feature calculation unit 1342 according to the present embodiment can more accurately extract unique feature information unique to the face of the target person.

The feature calculation unit 1342 illustrated in FIG. 5 includes a face feature calculation unit 1342a, an attribute determination unit 1342b, and an image unique information generation unit 1342c.

### Face Feature Calculation Unit 1342a

The face feature calculation unit 1342a calculates a face feature amount for the captured face image of the target person and generates face part information of the target person. As a method of calculating the face feature amount, many existing methods such as a method using deep learning and a method not using deep learning are known. For example, FaceNet is known as a face recognition model for calculating a high-dimensional face feature amount. Reference Literature 1:“”FaceNet: A Unified Embedding for Face Recognition and Clustering“, Internet <URL:https://arxiv. org/abs/1503.03832>” can be cited as a reference literature related to FaceNet.

For example, the face feature calculation unit 1342a generates the face part information using the existing method as described above. The face part information includes, for example, information indicating a relative positional relationship of face parts such as eyes, a nose, and a mouth, information regarding a shape of a face part, and information regarding a color of a face part such as a color of a pupil.

The face feature calculation unit 1342a outputs the generated face part information to the image acquisition unit 1343 as unique feature information.

### Attribute Determination Unit 1342b

The attribute determination unit 1342b determines the attribute of the target person based on at least one of the captured face image, the voice information, and the text information, and generates attribute information of the target person. The attribute of the target person indicates various properties to which the target person belongs, such as gender, race, age, and language.

The attribute determination unit 1342b determines the attribute of the target person and generates the attribute information by combining the attributes. For example, the attribute information includes information indicating the attribute of the target person, such as an Asian male in his/her 40s or a Caucasian female in his/her 60s.

By generating the learning data set using the attribute information, for example, even in a case where the face part information of the target person cannot be sufficiently obtained, the information processing apparatus 100 can estimate a person having a rough face feature and generate the learning data set including the person.

The attribute determination unit 1342b determines the attribute of the target person using, for example, an existing identification method. For example, as a method for identifying the age and gender of a person included in an image, a machine learning model called AgeGenderRecognitionRetail is known. Reference Literature 2:“”AgeGenderRecognitionRetail: A Machine Learning Model to Identify Age and Gender“, Internet <URL:https://medium.com/axinc-ai/agegenderrecognitionretail-a-machine-learning-model-to-identify-age-and-gender-8506510414b>” can be cited as a reference literature related to AgeGenderRecognitionRetail.

The attribute determination unit 1342b determines the attribute of the target person using the existing method based on at least one of the captured face image, the voice information, and the text information, and generates attribute information. The attribute determination unit 1342b outputs the generated attribute information to the image acquisition unit 1343 as unique feature information.

### Image Unique Information Generation Unit 1342c

The image unique information generation unit 1342c estimates, for example, the emotion of the target person based on at least one of the captured face image, the voice information, and the text information, and generates the unique image information of the target person.

For example, the image unique information generation unit 1342c estimates the emotion from the facial expression of the target person included in the captured face image. For example, Reference Literature 3 below proposes a deep learning model for recognizing emotions from facial expressions.

Reference Literature 3: Victor-emil Neagoe, Andrei-petru Brar, Nicusebe, Paul Robitu, “A Deep Learning Approach for Subject Independent Emotion Recognition from Facial Expressions”, Recent Advances in Image, Audio and Signal Processing, 2013.

In addition, for example, the image unique information generation unit 1342c estimates the emotion from the voice information. As a method of estimating an emotion from voice information, an existing method of estimating an emotion by analyzing physical feature amounts such as “intonation of voice” and “loudness of voice ” is known. In addition, in recent years, as a method of recognizing emotions, an emotion recognition method using deep learning has been performed as disclosed in Reference Literature 4.

Reference Literature 4: Daisuke Makabe and Tetsuo Kosaka, “Study on Emotion Recognition of Japanese Speech Using DNN”, Information Processing Society of Japan, Tohoku Branch Research Meeting, 15-6-B1-3, 2016.

In addition, the image unique information generation unit 1342c may estimate the emotion from the text information. For example, the image unique information generation unit 1342c can estimate the emotion based on the utterance contents of the target person included in the text information.

The image unique information generation unit 1342c estimates the emotion of the target person based on at least one of the captured face image, the voice information, and the text information, and generates the unique image information including the emotion information. The image unique information generation unit 1342c outputs the generated image unique information to the image acquisition unit 1343 as unique feature information.

Here, the image unique information generation unit 1342c of the feature calculation unit 1342 according to the present embodiment estimates the emotion of the target person as the image unique information. The facial expression deeply related to this emotion is important for generating the learning data set.

When the information processing apparatus 100 collects the learning image without considering the information regarding the facial expression, there is a risk that variations of the facial expression included in the collected learning image will be reduced. In the super-resolution model generated using the learning data set with less facial expression variation, there is a risk that the facial expression like the target person cannot be sufficiently reproduced.

Therefore, the image unique information generation unit 1342c of the present embodiment generates image unique information including emotion information. As a result, the information processing apparatus 100 can collect learning images with reference to the emotion information, and can generate a learning data set having a facial expression similar to the facial expression of the target person. By performing learning using this learning data set, the information processing apparatus 100 can realize higher quality face representation in the quality enhancement processing.

### Image Acquisition Unit 1343

The image acquisition unit 1343 in FIG. 5 searches the learning DB 121 using the unique feature information acquired from the feature calculation unit 1342, and acquires a plurality of learning images having feature information similar to the unique feature information from the learning DB 121.

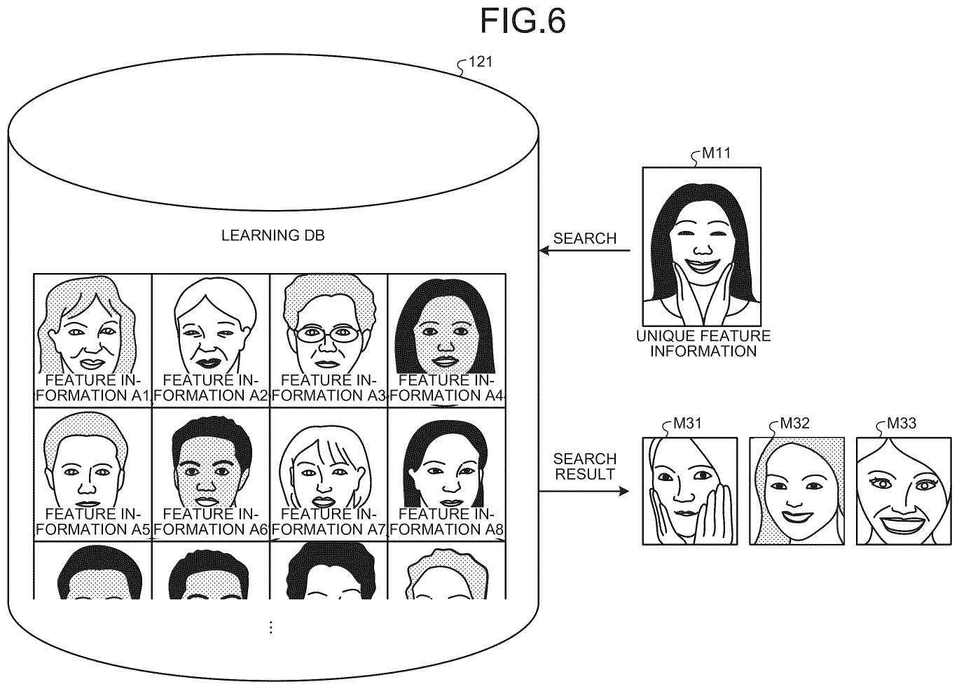

FIG. 6 is a diagram illustrating an example of image acquisition processing by the image acquisition unit 1343 according to an embodiment of the present disclosure.

As illustrated in FIG. 6, the image acquisition unit 1343 searches the learning DB 121 using a captured face image M11 and the unique feature information. As described above, the learning DB 121 stores a plurality of learning images in association with feature information (in the example of FIG. 6, feature information A1, A2, . . . ). The image acquisition unit 1343 acquires learning images M31, M32, M33, . . . similar to the unique feature information of the captured face image M11 from the learning DB 121 as search results.

Like the unique feature information, the feature information is a high-dimensional feature amount including at least one of face part information, attribute information, and image unique information. The image acquisition unit 1343 plots the learning image and the captured face image in the learning DB 121 on a high-dimensional feature amount space.

The image acquisition unit 1343 extracts the learning image according to the captured face image and the distance in the high-dimensional feature amount space. For example, the image acquisition unit 1343 acquires N learning images as a search result in the descending order of the captured face image and the distance in the high-dimensional feature amount space. Note that N is an arbitrary natural number. Alternatively, for example, the image acquisition unit 1343 acquires, as a search result, a learning image in which a distance between the captured face image and the learning image is a predetermined value or less in a high-dimensional feature amount space.

Returning to FIG. 5, the image acquisition unit 1343 outputs the acquired learning image to the output unit 1344.

### Output Unit 1344

The output unit 1344 outputs the learning image as a learning data set to the learning pair creation unit 134 (see FIG. 4) in the subsequent stage. The output unit 1344 may output all the learning images acquired by the image acquisition unit 1343 as the learning data set, or may output at least some of the learning images as the learning data set.

As described above, the information processing apparatus 100 can easily construct the substitute learning data set without taking time and effort to prepare a large number of face images of the target person. As a result, the information processing apparatus 100 can perform the learning and the quality enhancement processing using the substitute learning data set, and can realize the quality enhancement processing specialized for the face of the target person.

### 3. Processing Example of Information Processing Apparatus

### 3.1. Image Processing

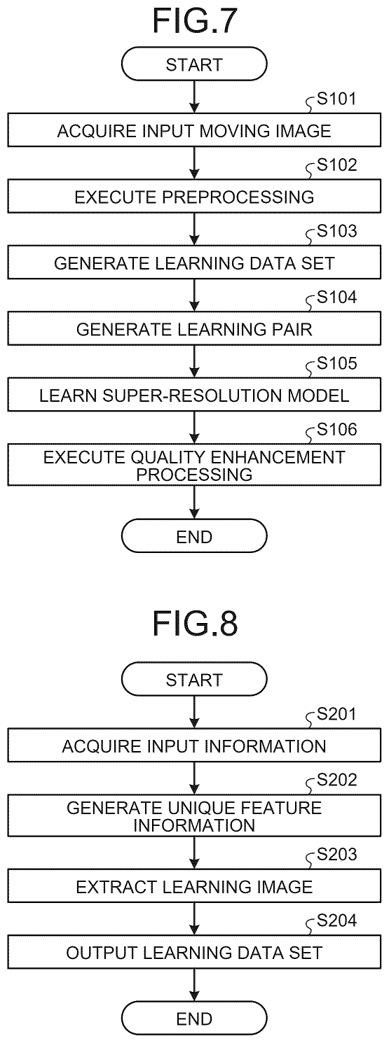

FIG. 7 is a flowchart illustrating an example of a flow of image processing according to an embodiment of the present disclosure. The image processing illustrated in FIG. 7 is executed by the information processing apparatus 100.

As illustrated in FIG. 7, the information processing apparatus 100 acquires the input moving image (step S101). Note that the input image acquired by the information processing apparatus 100 may be a still image. In addition, the information processing apparatus 100 can acquire text data and sound data in addition to the input moving image.

The information processing apparatus 100 executes preprocessing on the input moving image (step S102). For example, the information processing apparatus 100 generates a captured face image and generates text information and voice information as preprocessing. Note that, in a case where the preprocessing is unnecessary, the information processing apparatus 100 may omit step S102.

The information processing apparatus 100 generates a learning data set (step S103). The information processing apparatus 100 generates a learning data set by executing data set generation processing. The data set generation processing will be described later with reference to FIG. 8.

The information processing apparatus 100 generates a learning pair using the learning data set (step S104). The information processing apparatus 100 uses the learning image included in the learning data set as a teacher image. The information processing apparatus 100 sets the deterioration image generated from the teacher image as the student image. The information processing apparatus 100 sets the teacher image and the student image as a learning pair.

The information processing apparatus 100 learns the super-resolution model (step S105). For example, the information processing apparatus 100 generates a super-resolution model by performing learning processing using a learning pair based on the super-resolution technique.

The information processing apparatus 100 executes quality enhancement processing on the input moving image using the super-resolution model (step S106).

As a result, the information processing apparatus 100 can execute the quality enhancement processing on the input moving image with low image quality and generate the output moving image with higher image quality.

Note that the data set generation processing, the learning processing, and the quality enhancement processing may be performed at different timings or may be performed by different devices.

### 3.2. Data Set Generation Processing

FIG. 8 is a flowchart illustrating an example of a flow of data set generation processing according to an embodiment of the present disclosure. The data set generation processing illustrated in FIG. 8 is executed by the information processing apparatus 100.

As illustrated in FIG. 8, the information processing apparatus 100 acquires input information (step S201). The input information is, for example, information generated by the information processing apparatus 100 executing preprocessing on the input moving image. Examples of the input information include at least one of the captured face image, the text information, and the voice information. Note that the input information may include information other than these pieces of information.

The information processing apparatus 100 generates unique feature information from the input information (step S202). For example, the information processing apparatus 100 generates at least one of the face part information, the attribute information, and the image unique information as the unique feature information. Note that the unique feature information may include information other than these pieces of information.

The information processing apparatus 100 extracts a learning image based on the unique feature information (step S203). For example, the information processing apparatus 100 searches the learning DB 121 using the unique feature information, and extracts a plurality of learning images having feature information close to the unique feature information.

The information processing apparatus 100 outputs a learning data set including a plurality of learning images (step S204).

As described above, the information processing apparatus 100 according to the present embodiment can construct the learning data set based on the input moving image without preparing in advance a large amount of face images of the target person included in the input moving image and to be subjected to the quality enhancement processing. At this time, the information processing apparatus 100 can appropriately collect the learning data set including the face of the third person similar to the target person by using the unique feature information unique to the face of the target person obtained from the captured face image generated from the input moving image. Furthermore, the information processing apparatus 100 can more appropriately collect the learning data set including the face of the third person similar to the target person by using the unique feature information obtained from the text data and the sound data.

By learning the super-resolution model using the learning data set constructed using the unique feature information, the information processing apparatus 100 can perform the quality enhancement processing specialized for the face of the target person.

The image processing described above is performed on contents such as a movie, for example. Alternatively, the image processing described above may be performed in real time during an online meeting.

In this case, for example, the information processing apparatus 100 performs image processing (for example, collection of learning images, learning, and the like) at high speed using the video of the online meeting as the input moving image, and displays the output moving image after the quality enhancement processing on a display device (not illustrated).

As a result, the information processing apparatus 100 can provide a higher quality video to the user even in an online meeting in which image quality is likely to deteriorate due to the influence of communication quality and the like.

### 4. Hardware Configuration Example

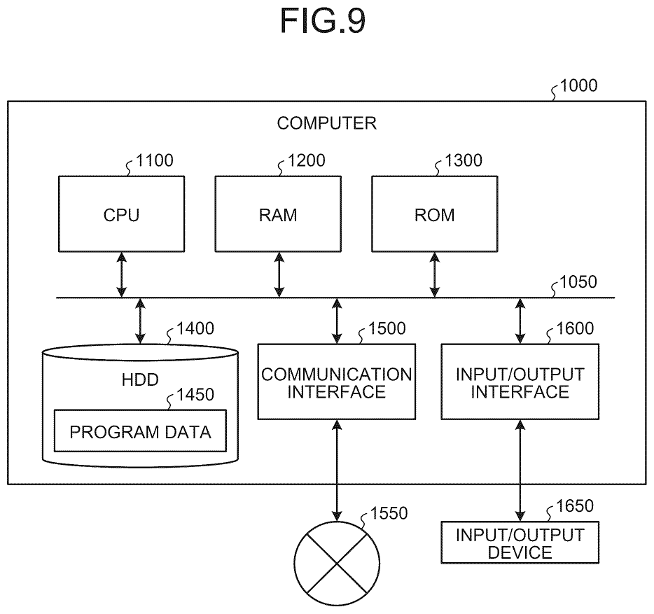

FIG. 9 is a diagram illustrating a hardware configuration example of the information processing apparatus 100.

The information processing of the information processing apparatus 100 is realized by, for example, a computer 1000. The computer 1000 includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program (program data 1450) stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a non-transitory computer-readable recording medium that non-transiently records a program executed by the CPU 1100, data used by the program, and the like. Specifically, the HDD 1400 is a recording medium that records the information processing program according to the embodiment as an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display device, a speaker, or a printer via the input/output interface 1600. Note that, in addition, the input/output interface 1600 may function as a media interface that reads a program and the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, and the like.

For example, in a case where the computer 1000 functions as the information processing apparatus 100 according to the embodiment, the CPU 1100 of the computer 1000 implements the functions of the above-described units by executing the information processing program loaded on the RAM 1200. In addition, the HDD 1400 stores an information processing program, various models, and various data according to the present disclosure. Note that the CPU 1100 reads the program data 1450 from the HDD 1400 and executes the program data, but as another example, these programs may be acquired from another device via the external network 1550.

### 5. Other Embodiments

The above-described embodiments are examples, and various modifications and applications are possible.

For example, a program for executing the above-described operation is stored and distributed in a computer-readable recording medium such as an optical disk, a semiconductor memory, a magnetic tape, or a flexible disk. Then, for example, the program is installed in a computer, and the above-described processing is executed to constitute the control device. At this time, the control device may be a device outside the information processing apparatus 100 (for example, a personal computer). In addition, the control device may be a device (for example, the control unit 130) inside the information processing apparatus 100.

In addition, the program may be stored in a disk device included in a server device on a network such as the Internet so that the program can be downloaded to a computer. In addition, the above-described functions may be realized by cooperation of an operating system (OS) and application software. In this case, a portion other than the OS may be stored in a medium and distributed, or a portion other than the OS may be stored in a server device and downloaded to a computer.

In addition, among the processings described in the above embodiments, all or a part of the processings described as being automatically performed can be manually performed, or all or a part of the processings described as being manually performed can be automatically performed by a known method. In addition, the processing procedure, specific name, and information including various data and parameters illustrated in the document and the drawings can be arbitrarily changed unless otherwise specified. For example, the various types of information illustrated in each figure are not limited to the illustrated information.

In addition, each component of each apparatus illustrated in the drawings is functionally conceptual, and is not necessarily physically configured as illustrated in the drawings. That is, a specific form of distribution and integration of each apparatus is not limited to the illustrated form, and all or a part of it can be functionally or physically distributed and integrated in an arbitrary unit according to various loads, usage conditions, and the like. Note that this configuration by distribution and integration may be performed dynamically.

In addition, the above-described embodiments can be appropriately combined in a region in which the processing contents do not contradict each other.

In addition, for example, the present embodiment can be implemented as any configuration constituting an apparatus or a system, for example, a processor as a system large scale integration (LSI) and the like, a module using a plurality of processors and the like, a unit using a plurality of modules and the like, a set obtained by further adding other functions to a unit, and the like (that is, a configuration of a part of the device).

Note that, in the present embodiment, a device or a system means a set of a plurality of components (devices, modules (parts), and the like), and it does not matter whether or not all the components are in the same housing. Therefore, a plurality of devices housed in separate housings and connected via a network and one device in which a plurality of modules is housed in one housing are both devices or systems.

In addition, for example, the present embodiment can adopt a configuration of cloud computing in which one function is shared and processed by a plurality of devices in cooperation via a network.

### 6. Conclusion

Although the embodiments of the present disclosure and modifications thereof have been described above, the technical scope of the present disclosure is not limited to the above-described embodiments as it is, and various modifications can be made without departing from the gist of the present disclosure. In addition, components of different embodiments and modifications may be appropriately combined.

In addition, the effects of the embodiments described in the present specification are merely examples and are not limited, and other effects may be provided.

### Appendix

Note that the present technology can also have the configuration below.
(1)

An information processing apparatus comprising
a control unit that
acquires unique feature information unique to a face of a target person from a low-quality captured face image including the face of the target person,
extracts a plurality of third person images different from the target person having a feature corresponding to a feature of the face of the target person from a learning database based on the unique feature information, and
outputs a learning data set for quality enhancement processing of improving quality of the low-quality captured face image based on the plurality of third person images.
(2)

The information processing apparatus according to (1), wherein the unique feature information includes attribute information of the target person.
(3)

The information processing apparatus according to (2), wherein the attribute information includes information regarding at least one of nationality, age, gender, race, and language of the target person.
(4)

The information processing apparatus according to any one of (1) to (3), wherein the unique feature information includes face part information regarding a part of the face of the target person.
(5)

The information processing apparatus according to (4), wherein the face part information includes information regarding any one of a position of the part in the face, a shape of the part, and a color of the part.
(6)

The information processing apparatus according to any one of (1) to (5), wherein the unique feature information includes image unique information that is information unique to the face of the target person in the captured face image.
(7)

The information processing apparatus according to (6), wherein the image unique information includes information regarding at least one of an emotion, an utterance, and a tone of a voice of the target person.
(8)

The information processing apparatus according to any one of (1) to (7), wherein the learning database stores the third person image having a higher quality than the captured face image and including a face of a third person in association with the unique feature information unique to the face of the third person.
(9)

The information processing apparatus according to any one of (1) to (8), wherein the control unit extracts the plurality of third person images based on a distance between the captured face image and the third person image in a high-dimensional feature amount space in which the captured face image and the third person image are plotted.
(10)

The information processing apparatus according to any one of (1) to (9), wherein the control unit outputs the learning data set including the plurality of third person images as teacher images.
(11)

The information processing apparatus according to any one of (1) to (10), wherein the plurality of third person images is used to generate a student image based on the captured face image.
(12)

The information processing apparatus according to any one of (1) to (11), wherein the control unit acquires the unique feature information based on text information extracted from a captured image including the target person.
(13)

The information processing apparatus according to any one of (1) to (12), wherein the control unit acquires the unique feature information based on voice information generated from sound data corresponding to a moving image including the target person.
(14)

An information processing method comprising:
acquiring unique feature information unique to a face of a target person from a low-quality captured face image including the face of the target person;
extracting a plurality of third person images different from the target person having a feature corresponding to a feature of the face of the target person from a learning database based on the unique feature information; and
outputting a learning data set for quality enhancement processing of improving quality of the low-quality captured face image based on the plurality of third person images.
(15)

A computer-readable non-transitory storage medium storing a program for causing a computer to implement:
acquiring unique feature information unique to a face of a target person from a low-quality captured face image including the face of the target person;
extracting a plurality of third person images different from the target person having a feature corresponding to a feature of the face of the target person from a learning database based on the unique feature information; and
outputting a learning data set for quality enhancement processing of improving quality of the low-quality captured face image based on the plurality of third person images.

### REFERENCE SIGNS LIST

100 INFORMATION PROCESSING APPARATUS
110 COMMUNICATION UNIT
120 STORAGE UNIT
121 LEARNING DB
130 CONTROL UNIT
131 ACQUISITION UNIT
132 PREPROCESSING UNIT
133 DATA SET CONSTRUCTION UNIT
134 LEARNING PAIR CREATION UNIT
135 LEARNING UNIT
136 IMAGE PROCESSING UNIT

What is claimed is:

1. An information processing apparatus comprising
a control unit that
acquires unique feature information unique to a face of a target person from a low-quality captured face image including the face of the target person,
extracts a plurality of third person images different from the target person having a feature corresponding to a feature of the face of the target person from a learning database based on the unique feature information, and
outputs a learning data set for quality enhancement processing of improving quality of the low-quality captured face image based on the plurality of third person images.

2. The information processing apparatus according to claim 1, wherein the unique feature information includes attribute information of the target person.

3. The information processing apparatus according to claim 2, wherein the attribute information includes information regarding at least one of nationality, age, gender, race, and language of the target person.

4. The information processing apparatus according to claim 1, wherein the unique feature information includes face part information regarding a part of the face of the target person.

5. The information processing apparatus according to claim 4, wherein the face part information includes information regarding any one of a position of the part in the face, a shape of the part, and a color of the part.

6. The information processing apparatus according to claim 1, wherein the unique feature information includes image unique information that is information unique to the face of the target person in the captured face image.

7. The information processing apparatus according to claim 6, wherein the image unique information includes information regarding at least one of an emotion, an utterance, and a tone of a voice of the target person.

8. The information processing apparatus according to claim 1, wherein the learning database stores the third person image having a higher quality than the captured face image and including a face of a third person in association with the unique feature information unique to the face of the third person.

9. The information processing apparatus according to claim 1, wherein the control unit extracts the plurality of third person images based on a distance between the captured face image and the third person image in a high-dimensional feature amount space in which the captured face image and the third person image are plotted.

10. The information processing apparatus according to claim 1, wherein the control unit outputs the learning data set including the plurality of third person images as teacher images.

11. The information processing apparatus according to claim 1, wherein the plurality of third person images is used to generate a student image based on the captured face image.

12. The information processing apparatus according to claim 1, wherein the control unit acquires the unique feature information based on text information extracted from a captured image including the target person.

13. The information processing apparatus according to claim 1, wherein the control unit acquires the unique feature information based on voice information generated from sound data corresponding to a moving image including the target person.

14. An information processing method comprising:
acquiring unique feature information unique to a face of a target person from a low-quality captured face image including the face of the target person;
extracting a plurality of third person images different from the target person having a feature corresponding to a feature of the face of the target person from a learning database based on the unique feature information; and
outputting a learning data set for quality enhancement processing of improving quality of the low-quality captured face image based on the plurality of third person images.

15. A computer-readable non-transitory storage medium storing a program for causing a computer to implement:
acquiring unique feature information unique to a face of a target person from a low-quality captured face image including the face of the target person;
extracting a plurality of third person images different from the target person having a feature corresponding to a feature of the face of the target person from a learning database based on the unique feature information; and
outputting a learning data set for quality enhancement processing of improving quality of the low-quality captured face image based on the plurality of third person images.
